(19) United States
(12) Patent Application Publication
(10) Pub. No.: US 2025/0309591 A1
(43) Pub. Date: Oct. 2, 2025

(54) MOVEABLE CONTACT ASSEMBLY FOR A CIRCUIT INTERRUPTER SYSTEM

(71) Applicant: EATON INTELLIGENT POWER LIMITED, DUBLIN 4 (IE)

(72) Inventors: CHUANCHUAN ZHUANG, Shanghai (CN); ERIK J. GOUHL, Fayetteville, GA (US)

(73) Assignee: EATON INTELLIGENT POWER LIMITED, DUBLIN 4 (IE)

(21) Appl. No.: 19/090,873

(22) Filed: Mar. 26, 2025

Related U.S. Application Data
(60) Provisional application No. 63/570,319, filed on Mar. 27, 2024.

(51) Int. Cl. H01R 13/713; H01R 24/78; H01R 25/00; H01R 105/00

(52) U.S. Cl. CPC H01R 13/7135; H01R 24/78; H01R 25/006; H01R 2105/00

(57) ABSTRACT

Disclosed herein are electrical outlets having circuit interrupter functionality, for instance, through a ground fault circuit interrupter (GFCI) system. The described electrical outlets include a moveable contact assembly configured to implement the circuit interrupter functionality. In one example, the moveable contact assembly includes a moveable load contact, a moveable receptacle contact, and a moveable arm bifurcated along a lateral plane into a first planar leg and a second planar leg. The moveable load is arranged on the first planar leg and the moveable receptacle is arranged on the second planar leg. The moveable arm may be moveable longitudinally into a RESET state where the moveable load contact engages a stationary load contact and the moveable receptacle contact engages a stationary receptacle contact to place the electrical outlet into normal operating conditions, where the stationary receptacle contact arranged at a different longitudinal height than the stationary load contact.

### CROSS-REFERENCE TO RELATED APPLICATION

This application claims priority to U.S. Provisional Patent Application Ser. No. 63/570,319, filed on Mar. 27, 2024 and titled “GROUND FAULT CIRCUIT INTERRUPTER RECEPTACLE INCLUDING SPLIT MOVABLE ARM,” the entire contents of which are incorporated herein by reference.

### TECHNICAL FIELD

The present disclosure is directed to a circuit interrupter system for an electrical device, such as a ground fault circuit interrupter (GFCI) for an electrical outlet, and, in particular, to a moveable contact assembly for the circuit interrupter system.

### BACKGROUND

Electrical devices may include a circuit interrupter system to provide protection from fault conditions, such as an arc fault or a ground fault. In general, a circuit interrupter system operates to shut off an electric circuit when the circuit interrupter system detects a fault condition, for instance, a ground fault due to current flowing along an unintended path.

A common type of circuit interrupter system is a ground fault circuit interrupter (GFCI) of an electrical outlet. GFCI systems require multiple elements in order to operate. For example, GFCI circuitry typically includes two sets of separable contacts: one set arranged to connect or disconnect to a load terminal, and another set arranged to connect or disconnect to a line or receptacle terminal. The sets of separable contacts may typically include stationary contacts and moveable contacts. The moveable contacts are automatically moved in response to a detected fault condition away from the stationary contacts to open the separable contacts, “tripping” the circuit, stopping the flow of current within the electrical outlet. A GFCI system requires various additional electrical components, for instance, relays, solenoids, and circuit boards, and other operating mechanisms, for instance, actuation assemblies for “test” and “reset” functions, in order to perform the operations of detecting the ground fault, interrupting the circuit, resetting the circuit, and/or testing the circuit interrupter functionality.

As a result, GFCI outlets typically require a thick, bulky housing with sufficient dimensions to contain all of the required electrical and mechanical components with sufficient space to fully operate. Such thick, bulky outlets consume valuable structural space, are more expensive, and are difficult and time-consuming to install compared with smaller and slimmer outlet form factors that have been developed.

Accordingly, electrical component manufacturers would benefit from circuit interrupter elements that required less operating space than conventional systems.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

The present disclosure describes electrical outlets having circuit interrupter functionality implemented, at least in part, via a moveable contact assembly. The moveable contact assembly may include a moveable arm bifurcated into multiple planar legs. Moveable contacts may be arranged on each of the planar legs. Movement of the moveable arm may cause independent movement of each planar leg and, therefore, corresponding independent movement of each of the moveable contacts to engage/disengage with stationary contacts to place the electrical outlets into certain operational states, such as a TRIP state or a RESET state.

In one example embodiment, a moveable contact assembly for an electrical outlet may include a moveable load contact, a moveable receptacle contact, and a moveable arm bifurcated along a lateral plane at a contact end into a first planar leg and a second planar leg. The moveable load contact may be arranged on the contact end of the first planar leg and the moveable receptacle contact may be arranged on the contact end of the second planar leg. The moveable arm may be moveable longitudinally into a RESET state where the moveable load contact engages a stationary load contact and the moveable receptacle contact engages a stationary receptacle contact to place the electrical outlet into normal operating conditions. The stationary receptacle contact may be arranged at a different longitudinal height than the stationary load contact.

In various embodiments of the moveable contact assembly, the first planar leg extends in a different longitudinal plane than the second planar leg.

In exemplary embodiments of the moveable contact assembly, the moveable arm includes a bend forming an upper structure at a non-contact end of the moveable arm arranged opposite of the contact end, a lower structure at the contact end, and a ramp connecting the upper structure and the lower structure, the contact end is configured to be arranged below the stationary load contact and the stationary receptacle contact, and the moveable load contact and the moveable receptacle contact are arranged at the contact end.

In some embodiments of the moveable contact assembly, the moveable arm is moveable longitudinally into a TRIP state where the moveable load contact is separated longitudinally from the stationary load contact by a load spacing and the moveable receptacle contact is separated longitudinally from the stationary receptacle contact by a receptacle spacing, and a first distance of the load spacing is different than a second distance of the receptacle spacing.

In various embodiments of the moveable contact assembly, a difference between the first distance and the second distance is about 1 mm to about 5 mm.

In exemplary embodiments of the moveable contact assembly, the moveable arm is moveable longitudinally during a RESETTING operation to cause the moveable load contact to engage the stationary load contact and the moveable receptacle contact to engage the stationary receptacle contact, and one of the moveable load contact or the moveable receptacle contact engages a respective one of the stationary load contact or the stationary receptacle contact prior to an other one of the moveable load contact or the moveable receptacle contact.

In some embodiments of the moveable contact assembly, the first planar leg and the second planar leg are configured to travel separately during the RESETTING operation.

In exemplary embodiments of the moveable contact assembly, in the RESET state, a first contact pressure between the moveable load contact and the stationary load contact and a second contact pressure between the moveable receptacle contact and the stationary receptacle contact are substantially equal.

In various embodiments of the moveable contact assembly, at least one of the moveable load contact or the moveable receptacle contact are formed of a material comprising silver.

In one example embodiment, a ground fault circuit interrupter (GFCI) outlet may include a load terminal having a stationary load contact, a receptacle terminal having a stationary receptacle contact, where the stationary receptacle contact is arranged at a different longitudinal height than the stationary load contact, a moveable arm bifurcated along a lateral plane at a contact end into a first planar leg and a second planar leg, where a moveable load contact is arranged on the contact end of the first planar leg and a moveable receptacle contact is arranged on the contact end of the second planar leg, wherein, in a TRIP state of the GFCI outlet, the moveable load contact is separated from the stationary load contact and the moveable receptacle contact is separated from the stationary receptacle contact, and a reset assembly comprising a reset button and a projection arranged in contact with a bottom portion of the moveable arm, wherein actuation of the reset button when the GFCI outlet is in the TRIP state initiates a RESETTING operation causing the projection to force the moveable arm to move longitudinally to cause the moveable load contact to engage the stationary load contact and the moveable receptacle contact to engage the stationary receptacle contact to place the electrical outlet into a RESET state.

In some embodiments of the GFCI outlet, further comprising a frame having at least one inlet and formed of a cover and a bottom housing, wherein the frame is configured to house the stationary load contact, the stationary receptacle contact, and the moveable arm, wherein a thickness of the frame is less than or equal to about 26 mm.

In various embodiments of the GFCI outlet, the load terminal is disposed along a side surface of the bottom housing, the receptacle terminal extends from the electrical inlet, and the receptacle contact is positioned laterally adjacent to and longitudinally below the load contact.

In some embodiments of the GFCI outlet, the reset assembly further comprises a latch pin disposed below the reset button and a reset spring configured to actuate the latch pin, the latch pin connected to a latch block at one end, the latch block having the projection disposed longitudinally below the movable arm and extending laterally across the movable arm.

In exemplary embodiments of the GFCI outlet, during the RESETTING operation, the latch pin moves longitudinally downward and engages the latch block and, upon release of the reset button, the latch pin moves the latch block longitudinally upward due to return force of the reset spring, the latch block thereby moving the moving arm longitudinally upward via the projection.

In some embodiments of the GFCI outlet, the first planar leg extends in a different longitudinal plane than the second planar leg. In various embodiments of the GFCI outlet, the moveable arm includes a bend forming an upper structure at a non-contact end of the moveable arm arranged opposite of the contact end, a lower structure at the contact end, and a ramp connecting the upper structure and the lower structure, the contact end is configured to be arranged below the stationary load contact and the stationary receptacle contact, and the moveable load contact and the moveable receptacle contact are arranged at the contact end.

In exemplary embodiments of the GFCI outlet, in the TRIP state, the moveable load contact is separated longitudinally from the stationary load contact by a load spacing and the moveable receptacle contact is separated longitudinally from the stationary receptacle contact by a receptacle spacing, and a first distance of the load spacing is different than a second distance of the receptacle spacing.

In some embodiments of the GFCI outlet, during the RESETTING operation, movement of the moveable arm longitudinally causes one of the moveable load contact or the moveable receptacle contact to engage a respective one of the stationary load contact or the stationary receptacle contact prior to an other one of the moveable load contact or the moveable receptacle contact.

In various embodiments of the GFCI outlet, the first planar leg and the second planar leg are configured to travel separately during the RESETTING operation.

In some embodiments of the GFCI outlet, in the RESET state, a first contact pressure between the moveable load contact and the stationary load contact and a second contact pressure between the moveable receptacle contact and the stationary receptacle contact are substantially equal.

In one embodiment, a moveable contact assembly for an electrical outlet may include a moveable load contact, a moveable receptacle contact; and a moveable arm bifurcated along a lateral plane at a contact end into a first planar leg and a second planar leg, the moveable load contact arranged on the contact end of the first planar leg and the moveable receptacle contact arranged on the contact end of the second planar leg. The moveable arm may be moveable longitudinally into a RESET state where the moveable load contact engages a stationary load contact and the moveable receptacle contact engages a stationary receptacle contact to place the electrical outlet into normal operating conditions, wherein the first planar leg extends in a different longitudinal plane than the second planar leg.

In some embodiments of the moveable contact assembly for the electrical outlet the moveable arm includes a bend forming an upper structure at a non-contact end of the moveable arm arranged opposite of the contact end, a lower structure at the contact end, and a ramp connecting the upper structure and the lower structure, and the contact end is configured to be arranged below the stationary load contact and the stationary receptacle contact.

In one example embodiment, a receptacle includes a frame having a cover and a bottom housing, the cover having an electrical inlet; a load terminal disposed on a side surface of the bottom housing and having a load contact disposed within the frame; a receptacle terminal extending from the electrical inlet and having a receptacle contact disposed within the frame, the receptacle contact being positioned laterally adjacent to and longitudinally below the load contact; a movable arm having one end split into a first planar leg and a second planar leg, the first planar leg having a first contact structured to connect to the load contact and the second planar leg having a second contact structured to connect to the receptacle contact during normal operation; and a reset button assembly including a reset button disposed laterally adjacent to the cover and actuatable longitudinally, the reset button assembly further including a latch pin disposed below the reset button and a reset spring structured to actuate the latch pin, the latch pin being connected to a latch block at one end, the latch block having a projection disposed longitudinally below the movable arm and extending laterally across the movable arm. Upon actuating the reset button, the receptacle is placed in a RESETTING STATE in which the latch pin is structured to move longitudinally downwardly and engage the latch block and, upon releasing the reset button, the latch pin is further structured to move the latch block longitudinally upwardly due to return force of the reset spring, the latch block being structured to move the moving arm longitudinally upwardly via the projection.

### BRIEF DESCRIPTION OF THE DRAWINGS

By way of example, features of the disclosed components and systems are described with reference to the accompanying drawings, in which:

FIG. 1 depicts an illustrative example of an electrical outlet including a circuit interrupter system in accordance with the present disclosure;

FIG. 2 depicts an illustrative example of internal operating components of an electrical outlet in accordance with the present disclosure;

FIG. 3 depicts an illustrative example of a TRIP state of internal operating components of an electrical outlet in accordance with the present disclosure;

FIG. 4 depicts an illustrative example of a RESETTING state of internal operating components of an electrical outlet in accordance with the present disclosure; and

FIG. 5 depicts an illustrative example of a RESET state of internal operating components of an electrical outlet in accordance with the present disclosure.

### DETAILED DESCRIPTION

Various features of an improved moveable contact assembly of a circuit interrupter system are described in the present disclosure, with reference to the accompanying drawings, in which one or more features of the moveable contact assembly and circuit interrupter system are shown and described. The various features described in the present disclosure and depicted in the accompanying drawings may be used independently of, or in combination, with each other. A moveable contact assembly and circuit interrupter system as disclosed herein may be embodied in many different forms and should not be construed as being limited to the examples set forth herein. Rather, these examples are provided to convey certain features of the moveable contact assembly and circuit interrupter system to those skilled in the art.

In some embodiments, the circuit interrupter system may be or may include a ground fault circuit interrupter (GFCI) system. Although examples of the present disclosure include a GFCI system, embodiments are not so limited, for instance, the moveable contact assembly and/or components thereof may be used with other existing or future-developed circuit interrupter systems.

In response to the detection of a fault condition, a circuit interrupter system, such as a GFCI, operates to disable the flow of current through the circuit of the electrical outlet. For example, a GFCI may cause the movement of certain moveable contacts away from corresponding stationary contacts (e.g., load and line contacts) to disconnect (or “open”) the contacts, which results in the interruption of the circuit of the electrical outlet.

When the outlet is in a faulted (or “tripped”) state, a reset assembly may be operated to “reset” the electrical outlet to normal operation. For example, a RESET button of the reset assembly becomes manually actuatable in the faulted state. Actuation of the RESET button causes the moveable contacts to move back into engagement with the stationary contacts to reestablish the electrical path of the circuit, thereby returning the outlet to normal operating conditions.

In various embodiments, the moveable contact assembly may include moveable contacts arranged on a contact end of one or more moveable arms. The contact end of each moveable arm may be bifurcated, forked, split, or otherwise divided into two planar legs, with one moveable contact arranged on or near the end of each of the two planar legs. Each moveable contact may be configured to engage one corresponding stationary contact. In some embodiments, the stationary contacts may include one or more sets of load contacts (or “stationary load contacts”) and line or receptacle contacts (or “stationary receptacle contacts”). The moveable contacts may include corresponding sets of first contacts (or “moveable load contacts”) and second contacts (or “moveable receptacle contacts”). Movement of the moveable arm may cause the moveable contacts to engage with or disengage from the corresponding stationary contacts, depending on the direction of movement of the moveable arm.

The moveable contact assembly of the described embodiments may provide multiple technological advantages over existing circuit interrupter systems. One non-limiting example of a technological advantage may include arranging the moveable contacts on separate planar legs to allow the moveable contacts to travel separately and/or independently. For instance, each of the moveable contacts may move in a different plane than other moveable contacts.

Another non-limiting example of a technological advantage may include splitting one end of the movable arm to facilitate the effective and efficient balancing of contact pressures between the stationary contacts and the moveable contacts in a limited space. For example, the contact pressures between the stationary load contact-moveable load contact and the stationary receptacle contact-moveable receptacle contact may be balanced and maintained within a smaller operating space than required for conventional interrupter circuit systems.

A further non-limiting example of a technological advantage may include configuring the shape of the moving arm (for instance, splitting one end of the movable arm, forming a bend in the movable arm, and/or adjusting the split spacing between the planar legs) alone or in combination with varying the contact materials (including, without limitation, silver) to facilitate effective optimization of the conduction properties of the contacts based on the equal and balanced contact pressures, for instance, applied by the moveable contacts via the planar legs.

The thickness of a conventional GFCI outlet is about 32.358 mm (1.27 inches). Lower-volume and/or slimmer outlet form factors have been developed, which are cheaper to manufacture, require less structural space, and are quicker and easier to install compared to conventional GFCI outlets. However, lower-volume outlets face space constraints, particularly for all of the components and operating space required for a GFCI system. Such space constraints often lead to design and operating challenges, including, without limitation, contact force disparities between the separable contacts (e.g., between the stationary and moveable contacts). Contact force disparities may lead to sub-optimal electrical conductivities for the separable contacts. For example, if one set of the separable contacts (e.g., the stationary and moveable load contacts) has a higher contact force, that may compromise the contact force on the other set of separable contacts (e.g., the stationary and moveable receptacle contacts), which negatively impacts the electrical conductivity of the contacts, particularly the contacts experiencing the smaller contact force.

However, a circuit interrupter system using a contact assembly configured according to some embodiments may provide for constant and balanced contact pressures between the contact pairs (for instance, the stationary load contact-moveable load contact and the stationary receptacle contact-moveable receptacle contact) within a smaller operating space than required for conventional interrupter circuit systems. For example, a GFCI outlet using a contact assembly configured according to some embodiments may be able to operate within a housing having a thickness less than or equal to about 26.162 mm (1.03 inches), while meeting or exceeding standard operating requirements. In some examples, a GFCI outlet using a contact assembly configured according to some embodiments may be able to operate within a housing having a thickness of less than about 20 mm (0.79 inches), about 20 mm (0.79 inches), about 25 mm (0.98 inches), about 30 mm (1.18 inches), greater than about 30 mm (1.18 inches), or any value or range between any two of the aforementioned values (including endpoints). Embodiments are not limited in this context.

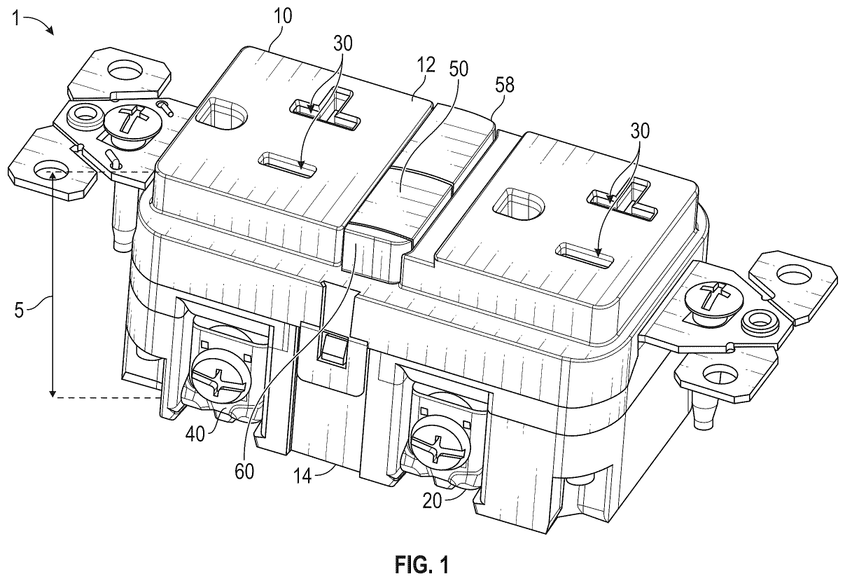

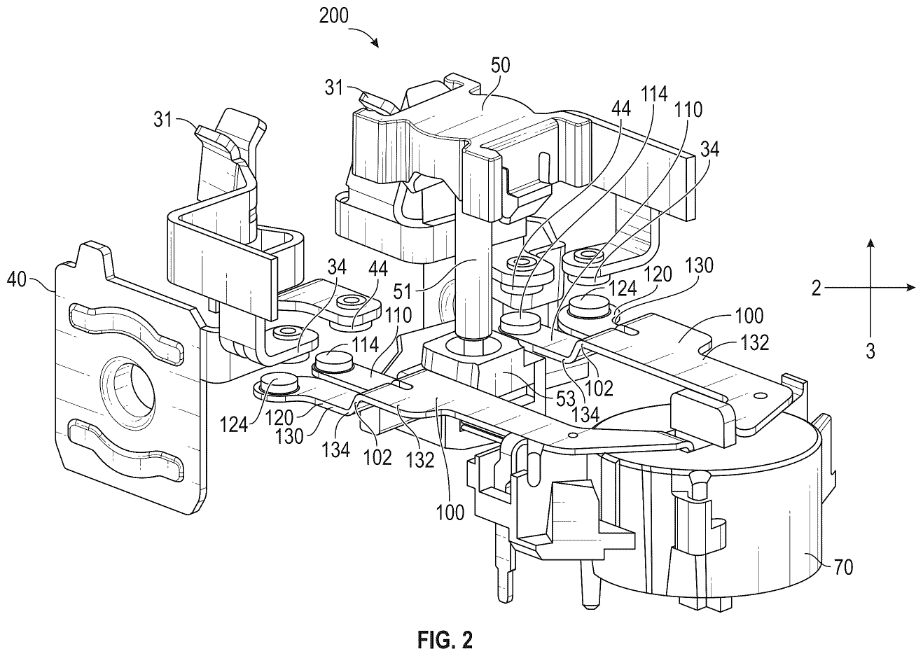

FIG. 1 depicts an illustrative example of an electrical outlet including a circuit interrupter system in accordance with the present disclosure, and FIG. 2 depicts an illustrative example of internal operating components of an electrical outlet in accordance with the present disclosure. The electrical outlet and internal operating components depicted in FIGS. 1 and 2 are for illustrative purposes. Electrical outlets and internal operating components in accordance with the present disclosure may include more or fewer components.

Referring to FIGS. 1 and 2, in various embodiments, an electrical outlet 1 may be configured as a GFCI outlet. The GFCI outlet 1 may include a housing or frame 10 formed of a cover 12 and a bottom housing 14. In various embodiments, a middle housing may be arranged between the cover 12 and the bottom housing 14. In some embodiments, a thickness 5 of the frame 10 is equal to or less than about 26.162 mm (1.03 inches). The cover 12 includes electrical slots outlets (or conversely, inlets) 30 configured to receive corresponding prongs of a prong connector or plug. Although the present disclosure, including FIG. 1, describes the GFCI outlet 1 as having double outlets 30, embodiments are not so limited, as this configuration is for the illustrative purposes only. For example, the GFCI outlet 1 may include more or fewer electrical outlets 30.

In some embodiments, the GFCI outlet 1 may also include a status indicator 60 configured to indicate one or more states of the GFCI outlet 1. For example, without limitation, the status indicator 60 may include an LED light configured to indicate if the GFCI outlet 1 is in a TRIP, RESETTING, and/or RESET (normal) state. The GFCI outlet 1 may include one or more function actuators (or buttons), such as a RESET button 50 and/or a TEST button 58.

The GFCI outlet 1 may include one or more terminals, such as load terminals 40 and receptacle terminals 31. In various embodiments, the load terminals 40 are disposed on a side surface of the bottom housing 14 and have load contacts 44 disposed within the frame 10. In some embodiments, the receptacle terminals 31 extend from the electrical outlets 30 and have receptacle contacts 34 disposed within the frame 10. In some embodiments, the receptacle contacts 34 may be stationary contacts, for instance, the stationary receptacle contacts. In some embodiments, the load contacts 44 may be stationary contacts, for instance, the stationary load contacts. For example, during a TRIP and/or RESET operation, the receptacle contacts 34 and the load contacts 44 are stationary. In various embodiments, the receptacle contacts 34 are positioned laterally adjacent to and longitudinally below each respective one of the load contacts 44.

The GFCI outlet 1 may include moveable contacts 114 and 124. Moveable contact 114 (the “first contact” or the “moveable load contact”) may be configured to engage with load contact 44, and moveable contact 124 (the “second contact” or the “moveable receptacle contact”) may be configured to engage with the receptacle contact 34. In some embodiments, moveable contacts 114 and 124 may be moveable during a TRIP, RESETTING, and/or RESET operation. For example, moveable contacts 114 and 124 may be moved away from stationary contacts 34 and 44 during a TRIP operation (i.e., to open or trip the circuit of the GFCI outlet 1) and may be moved toward stationary contacts 34 and 44 in a RESETTING or RESET operation to form an electrical connection between moveable contacts 114 and 124 and stationary contacts 34 and 44 to reset the GFCI outlet to normal operating conditions.

Unless specifically specified otherwise, the relative positions of internal components of the GFCI outlet 1 are described with reference to the longitudinal axis 3 and the lateral axis 2 orthogonal to the longitudinal axis 3. The term “longitudinally higher” means longitudinally closer to the cover 12 and further away from the bottom housing 14, and the term “longitudinally lower” means longitudinally further away from the cover 12 and closer to the bottom housing 14. The term “longitudinally upward” (or variations thereof) means moving longitudinally toward the cover 12 and away from the bottom housing 14. The term “longitudinally downward” (or variations thereof) means moving longitudinally away from the cover 12 and toward the bottom housing 14. The term “laterally adjacent” means adjacent with respect to the plane defined by lateral axis 2.

The contacts 34, 44, 114, and 124 may be formed from various materials. In various embodiments, one or more of the contacts 34, 44, 114, and 124 may be formed of a metal material. In various embodiments, one or more of the contacts 34, 44, 114, and 124 may be formed of silver, copper, gold, platinum, palladium, tungsten, nickel, combinations thereof, and/or alloys thereof. In various embodiments, one or more of the contacts 34, 44, 114, and 124 may be formed of silver, a material containing silver, and/or an alloy thereof. In one non-limiting example, in various embodiments, one or more of the contacts 34, 44, 114, and 124 may be formed of silver, a material containing silver, and/or an alloy thereof to assist with the balancing of the contact pressures between the contacts (for instance, moveable contacts 114 and 124) upon completion of a RESET operation.

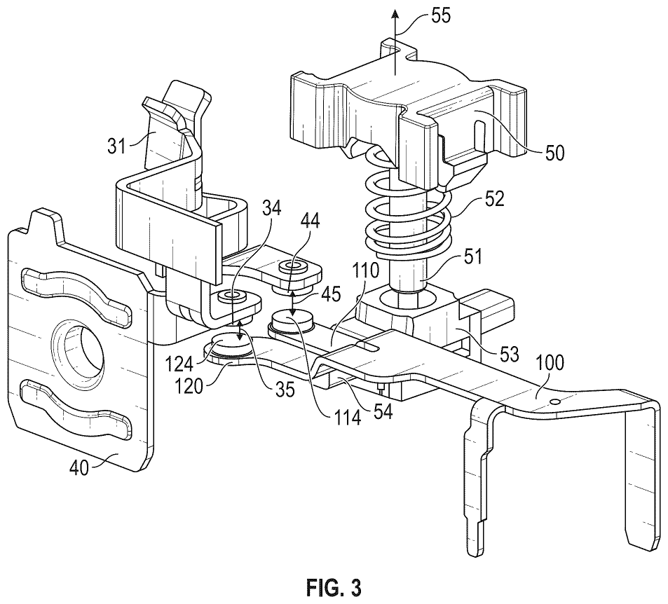

In some embodiments, the GFCI outlet 1 may include one or more moveable arms 100. In various embodiments, the GFCI outlet 1 may include two moveable arms 100. In various embodiments, each moveable arm 100 may include a non-contact end arranged in a base 70 and a contact end having a plurality of moveable contacts arranged on an upper surface thereof. The moveable arm may be generally planar in shape, for instance, wider in a lateral plane compared with a longitudinal direction (see, for example, elements 2 and 3 of FIG. 3 for illustrative longitudinal and lateral directions within the GFCI outlet 1). An upper surface of a portion of the moveable arm 100 that includes the contact end may be bifurcated, forked, split, or otherwise divided into two planar legs 110 and 120. Each of the planar legs 110 and 120 may have a moveable contact 114 or 124 arranged on a surface of a contact end thereof, such as a longitudinally upward surface, facing a respective stationary contact 34 or 44. For instance, in one embodiment, the moveable contact 114 may be arranged on the planar leg 110 and the moveable contact 124 may be arranged on the planar leg 120. Although the stationary contacts 34 and 44 and the moveable contacts 114 and 124 are arranged in a certain lateral and longitudinal configurations in FIG. 2, embodiments are not so limited. For example, the moveable contact 114 may be arranged on the planar leg 120 and the moveable contact 124 may be arranged on the planar leg 110 (with corresponding arrangement of the stationary contacts 34 and 44).

Accordingly, in some embodiments, the first planar leg 110 has a first contact 114 structured to connect to the load contact 44 and the second planar leg 120 has a second contact 124 structured to connect to the receptacle contact 34 during normal operation.

The inner lateral distance (i.e., the distance of the split) between the first planar leg 110 and the second planar leg 120 may vary according to some embodiments. In one non-limiting example, the inner lateral distance between the planar legs 110 and 120 may be about 0.762 mm (0.03 inches). In other non-limiting examples, the inner lateral distance between the planar legs 110 and 120 may be about 0.25 mm (0.0098 inches), about 0.5 mm (0.019 inches), about 0.75 mm (0.029 inches), about 1 mm (0.039 inches), about 2 mm (0.079 inches), about 3 mm (0.12 inches), about 5 mm (0.20 inches), greater than about 5 mm (0.20 inches), or any value or range between any two of the aforementioned values (including endpoints).

The length of the split between the first planar leg 110 and the second planar leg 120 may vary according to some embodiments. In some non-limiting examples, the length of the split between the planar legs 110 and 120 may be about 2 mm (0.079 inches), about 3 mm (0.12 inches), about 5 mm (0.2 inches), about 10 mm (0.39 inches), about 20 mm (0.68 inches), about 50 mm (1.96 inches), about 100 mm (3.93), greater than about 100 mm (3.93 inches), or and any distance or range between any two of the aforementioned values (including endpoints).

In some embodiments, the first planar leg 110 and the second planar leg 120 may extend in the same or substantially the same plane. In various embodiments, the first planar leg 110 and the second planar leg 120 may extend in different planes. For example, the first planar leg 110 may extend in a longitudinally lower plane compared with the second planar leg 120. In another example, the first planar leg 110 may extend in a longitudinally higher plane compared with the second planar leg 120.

In some embodiments, the movable arm 100 may include a bend 102, resulting from formation of an upper structure 132, a ramp 134, and a lower structure 130. The lower structure 130 may be positioned longitudinally lower than the upper structure 134. The moveable contacts 114 and 124 may be arranged on the lower structure 130. The upper structure 132 may be required to be at a longitudinally higher position, for instance, compared with the moveable contacts 114 and 124, during certain states, such as a TRIP state to maintain structural or electrical connectivity to certain circuit elements of the GFCI outlet 1.

In one example, the bend 102 may be configured to provide more room for GFCI operations. For instance, the bend 102 may be configured to provide more room for a TRIP operation of the moveable contacts 114 and 124 where, in comparison with conventional GFCI configurations, there is typically insufficient longitudinal spacing for the full range of motion required of the moveable contacts during a TRIP operation.

In various embodiments, the GFCI outlet 1 may include a reset assembly 200 configured to provide a RESETTING or RESET function for the GFCI outlet 1. The reset assembly 200 includes a reset button 50 accessible externally through the cover 12 and actuatable longitudinally. The reset assembly 200 further includes a latch pin 51 disposed below the reset button 50, and a reset spring 52 arranged around the latch pin 51. The latch pin 51 is connected to a latch block 53 at one end. The latch block 53 includes a projection 54 disposed longitudinally below the movable arm 100 and extending laterally across at least a portion of the movable arm 100. In one embodiment, the projection 54 may extend laterally across only the first planar leg 110. In another embodiment, the projection 54 may extend laterally across both the first and second planar legs 110 and 120.

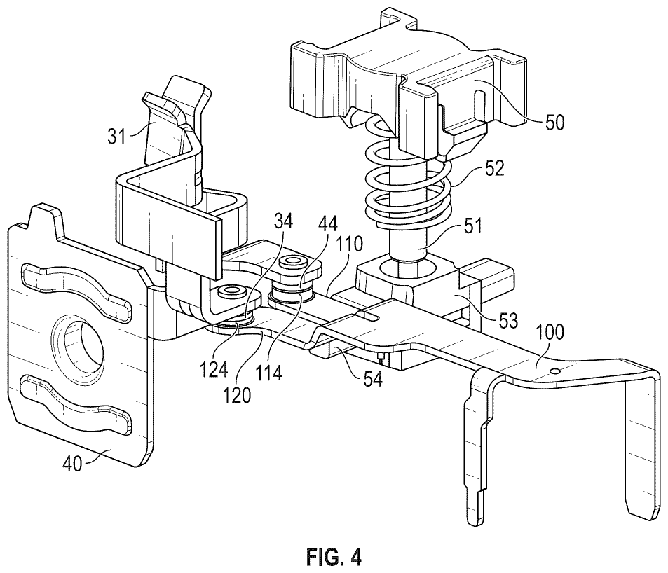

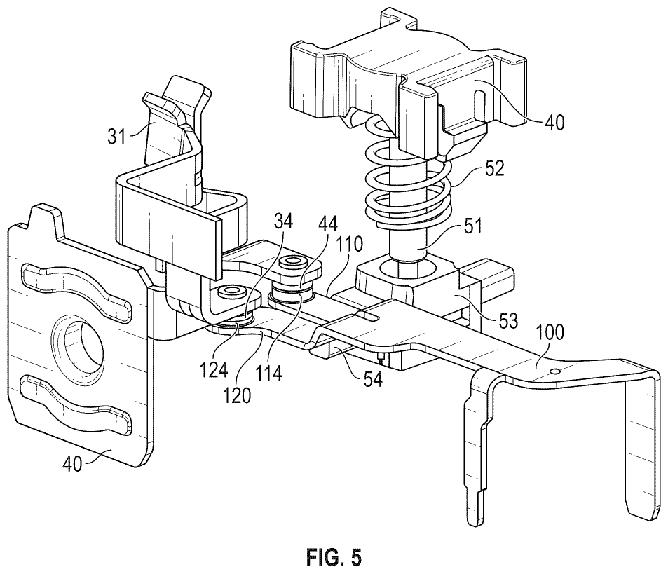

FIGS. 3-5 depict illustrative examples of certain states of the internal operating components of an electrical outlet in accordance with the present disclosure. More specifically, FIG. 3 depicts a TRIP state, FIG. 4 depicts a RESETTING state, and FIG. 5 depicts a RESET (or normal operating condition) state of the internal operating components of an electrical outlet in accordance with the present disclosure. With reference to FIGS. 3-5, in order to simplify the figures, only one movable arm 100 and the pertinent components thereof are depicted.

Referring to FIG. 3, in a TRIP state, all of the contacts 34, 44, 114, and 124 are disconnected. For example, the moveable load contact 114 and the stationary load contact 44 are open and released from each other, and the moveable receptacle contact 124 and the stationary receptacle contact 34 are open and released from each other. In the TRIP state, the reset button 50 may be forced in an upward direction 55 and in an actuatable state (i.e., able to be pressed downward to initiate a RESETTING operation).

In some embodiments, a first (or load) spacing 45 between the moveable load contact 114 and the stationary load contact 44 may be different than a second (or receptacle) spacing 35 between the moveable receptacle contact 124 and the stationary receptacle contact 34. In general, the load spacing 45 is the longitudinal distance between the moveable load contact 114 and the stationary load contact 44 when the GFCI outlet is in the TRIP state (i.e., the moveable load contact 114 and the stationary load contact 44 are fully separated). The receptacle spacing 35 is the longitudinal distance between the moveable receptacle contact 124 and the stationary receptacle contact 34 when the GFCI outlet is in the TRIP state. In some embodiments, for example, the load contact spacing 45 may be greater than the receptacle spacing 35. In other embodiments, for example, the load contact spacing 45 may be less than the receptacle spacing 35. In various embodiments, the load contact spacing 45 and/or the receptacle spacing 35 may be configured based on a longitudinal arrangement of the load contact 44 and/or the receptacle contact 34 (for instance, the load contact 44 may be arranged longitudinally higher than the receptacle contact 34, or vice versa). In some embodiments, the load contact spacing 45 and/or the receptacle spacing 35 may be configured based on a longitudinal arrangement of the moveable load contact 114 and/or the moveable receptacle contact 124 (for example, the first planar leg 110 may be arranged longitudinally higher than the second planar leg 120, or vice versa). In some embodiments, the load contact spacing 45 and/or the receptacle spacing 35 may be configured based on longitudinal arrangement of one or more of the stationary contacts 34 and 44 and one or more of the moveable contacts 114 and 124.

The load contact spacing 45 and the receptacle spacing 35 may have various values or ranges according to some embodiments. In one non-limiting example, the load contact spacing 45 may be about 2.3 mm (e.g., 2.286 mm) (0.08 inches). In some non-limiting examples, the load contact spacing 45 may be less than about 2.0 mm (0.079 inches), about 2.0 mm (0.079 inches), about 3.0 mm (0.12 inches), about 5 mm (0.20 inches), about 10 mm (0.39 inches), greater than about 10 mm (0.39 inches), or any value or range between any two of the aforementioned values (including endpoints). In one non-limiting example, the receptacle contact spacing 35 may be about 1.3 mm (e.g., 1.27 mm) (0.05 inches). In some non-limiting examples, the receptacle contact spacing 35 may be less than about 1.0 mm (0.039 inches), about 1.0 mm (0.039 inches), about 2.0 mm (0.079 inches), about 3.0 mm (0.12 inches), about 5 mm (0.20 inches), about 10 mm (0.39 inches), greater than about 10 mm (0.39 inches), or any value or range between any two of the aforementioned values (including endpoints).

In some embodiments, the first planar leg 110 and the second planar leg 120 may extend in different planes, resulting in the ends of the first planar leg 110 and the second planar leg at the contact end of the moveable arm 110 being at different longitudinal points or heights. In one non-limiting example, a first end of the first planar leg 110 (i.e., the end of the first planar leg 110 at the contact end of the moveable arm 100) may be arranged at a higher longitudinal height compared with a second end of the second planar leg 120 (i.e., the end of the second planar leg 120 at the contact end of the moveable arm 100). In another non-limiting example, the first end of the first planar leg 110 may be arranged at a lower longitudinal height compared with the second end of the second planar leg 120. In various embodiments, the longitudinal height difference between the first end of the first planar leg 110 and the second end of the second planar leg 120 may be the same or substantially similar to correspond with the load contact spacing 45 and/or the receptacle spacing 35.

Referring to FIG. 4, manual actuation (e.g., pressing down) of the reset button 50 initiates a RESETTING state for the GFCI outlet 1. In the RESETTING state, the latch pin 51 is structured to move longitudinally downward and engage the latch block 53 and, upon releasing the reset button 50, the latch pin 51 is further structured to move the latch block 53 longitudinally upward due to the return force of the reset spring 52. The projection 54 engages the moving arm 100 and the latch block 53 is structured to move the moving arm 100 longitudinally upwardly via the projection 54. Movement of the moving arm 100, and the resulting movement of the first and second planar legs 110 and 120, causes corresponding movement of the moveable contacts 114 and 124.

The moveable receptacle contact 124 and the stationary receptacle contact 34 engage (or are “closed”) first due to the difference between the contact spacings 35 and 45. Upon closing of the moveable receptacle contact 124 and the stationary receptacle contact 34, the return spring force continues to apply to the movable arm 100. Subsequently, the moveable load contact 114 and the stationary load contact 34 engage and become closed. Upon closing of all of the contacts 114, 124, 34, and 44, the return spring force still continues to apply such that the first (or load) contact pressure between the moveable load contact 114 and the stationary load contact 34 remains equal and balanced to the second (or receptacle) contact pressure between the moveable receptacle contact 124 and the stationary receptacle contact 34. In one non-limiting example, the equal (or substantially equal) and balanced (or substantially balanced) load and receptacle contact pressures may include pressures within 10% variance of each other. In other non-limiting examples, the pressure variance between the load and receptacle contact pressures may be about 2%, about 5%, about 10%, about 20%, or any value or range between any two of the aforementioned values (including endpoints). The equal (or substantially equal) and balanced (or substantially balanced) load and receptacle contact pressures allow optimal conduction among the contacts 114, 124, 44, and 34.

Referring to FIG. 5, upon the return of the reset button 50 to the original position (e.g., the unpressed position or state), the RESETTING state is terminated and the GFCI outlet 1 is in a RESET state in which the GFCI outlet 1 performs normal operations (i.e., providing power to electrical devices plugged into the GFCI outlet 1).

Accordingly, by splitting one end of the movable arm 100, the movable arm 100 not only allows the first (or moveable load) contact 114 and the second (or moveable receptacle) contact 124 to travel separately and/or independently, but also balances the contact pressures between the moveable load contact 114 and the stationary load contact 34 and the moveable receptacle contact 124 and the stationary receptacle contact 44 in a limited space within the GFCI outlet 1, neither of which a conventional GFCI, or other current interrupter, outlet can achieve. Further, by adjusting the shape of the moveable arm 100 (i.e., splitting one end of movable arm 100, including a bend 102 to the movable arm 100, adjusting the split spacing between the first and second planar legs 110 and 120, etc.) and/or varying contact materials (e.g., without limitation, silver), a GFCI outlet 1 having a moveable contact assembly configured according to various embodiments effectively optimizes the conduction properties of the contacts due to the equal and balanced contact pressures applied between the moveable load contact 114 and the stationary load contact 34 and the moveable receptacle contact 124 and the stationary receptacle contact 44.

While specific embodiments have been described in detail, it will be appreciated by those skilled in the art that various modifications and alternatives to those details could be developed in light of the overall teachings of the present disclosure. Accordingly, the particular arrangements disclosed are meant to be illustrative only and not limiting as to the scope of disclosed concept which is to be given the full breadth of the claims appended and any and all equivalents thereof.

What is claimed is:

1. A moveable contact assembly for an electrical outlet, comprising:
a moveable load contact;
a moveable receptacle contact; and
a moveable arm bifurcated along a lateral plane at a contact end into a first planar leg and a second planar leg, the moveable load contact arranged on the contact end of the first planar leg and the moveable receptacle contact arranged on the contact end of the second planar leg,
wherein the moveable arm is moveable longitudinally into a RESET state where the moveable load contact engages a stationary load contact and the moveable receptacle contact engages a stationary receptacle contact to place the electrical outlet into normal operating conditions, the stationary receptacle contact arranged at a different longitudinal height than the stationary load contact.

2. The moveable contact assembly for the electrical outlet of claim 1, wherein the first planar leg extends in a different longitudinal plane than the second planar leg.

3. The moveable contact assembly for the electrical outlet of claim 1, wherein:
the moveable arm includes a bend forming an upper structure at a non-contact end of the moveable arm arranged opposite of the contact end, a lower structure at the contact end, and a ramp connecting the upper structure and the lower structure, and
the contact end is configured to be arranged below the stationary load contact and the stationary receptacle contact.

4. The moveable contact assembly for the electrical outlet of claim 1, wherein:
the moveable arm is moveable longitudinally into a TRIP state where the moveable load contact is separated longitudinally from the stationary load contact by a load spacing and the moveable receptacle contact is separated longitudinally from the stationary receptacle contact by a receptacle spacing, and
a first distance of the load spacing is different than a second distance of the receptacle spacing.

5. The moveable contact assembly for the electrical outlet of claim 4, wherein a difference between the first distance and the second distance is about 1 mm to about 5 mm.

6. The moveable contact assembly for the electrical outlet of claim 1, wherein:
the moveable arm is moveable longitudinally during a RESETTING operation to cause the moveable load contact to engage the stationary load contact and the moveable receptacle contact to engage the stationary receptacle contact, and
one of the moveable load contact or the moveable receptacle contact engages a respective one of the stationary load contact or the stationary receptacle contact prior to an other one of the moveable load contact or the moveable receptacle contact.

7. The moveable contact assembly for the electrical outlet of claim 6, wherein the first planar leg and the second planar leg are configured to travel separately during the RESETTING operation.

8. The moveable contact assembly for the electrical outlet of claim 1, wherein, in the RESET state, a first contact pressure between the moveable load contact and the stationary load contact and a second contact pressure between the moveable receptacle contact and the stationary receptacle contact are substantially equal.

9. The moveable contact assembly for the electrical outlet of claim 1, wherein at least one of the moveable load contact or the moveable receptacle contact are formed of a material comprising silver.

10. A ground fault circuit interrupter (GFCI) outlet, comprising:
a load terminal having a stationary load contact;
a receptacle terminal having a stationary receptacle contact, the stationary receptacle contact arranged at a different longitudinal height than the stationary load contact;
a moveable arm bifurcated along a lateral plane at a contact end into a first planar leg and a second planar leg, a moveable load contact is arranged on the contact end of the first planar leg and a moveable receptacle contact is arranged on the contact end of the second planar leg, wherein, in a TRIP state of the GFCI outlet, the moveable load contact is separated from the stationary load contact and the moveable receptacle contact is separated from the stationary receptacle contact; and
a reset assembly comprising a reset button and a projection arranged in contact with a bottom portion of the moveable arm, wherein actuation of the reset button when the GFCI outlet is in the TRIP state initiates a RESETTING operation wherein the projection moves to force the moveable arm to move longitudinally to cause the moveable load contact to engage the stationary load contact and the moveable receptacle contact to engage the stationary receptacle contact to place the electrical outlet into a RESET state.

11. The GFCI outlet of claim 10, further comprising a frame having at least one inlet and formed of a cover and a bottom housing, wherein the frame is configured to house the stationary load contact, the stationary receptacle contact, and the moveable arm, wherein a thickness of the frame is less than or equal to about 26 mm.

12. The GFCI outlet of claim 10, wherein the reset assembly further comprises a latch pin disposed below the reset button and a reset spring configured to actuate the latch pin, the latch pin connected to a latch block at one end, the latch block having the projection disposed longitudinally below the movable arm and extending laterally across the movable arm.

13. The GFCI outlet of claim 12, wherein, during the RESETTING operation, the latch pin moves longitudinally downward and engages the latch block and, upon release of the reset button, the latch pin moves the latch block longitudinally upward due to a return force of the reset spring, the latch block thereby moving the moving arm longitudinally upward via the projection.

14. The GFCI outlet of claim 10, wherein the first planar leg extends in a different longitudinal plane than the second planar leg.

15. The GFCI outlet of claim 10, wherein:
the moveable arm includes a bend forming an upper structure at a non-contact end of the moveable arm arranged opposite of the contact end, a lower structure at the contact end, and a ramp connecting the upper structure and the lower structure, and
the contact end is configured to be arranged below the stationary load contact and the stationary receptacle contact.

16. The GFCI outlet of claim 10, wherein:
in the TRIP state, the moveable load contact is separated longitudinally from the stationary load contact by a load spacing and the moveable receptacle contact is separated longitudinally from the stationary receptacle contact by a receptacle spacing, and
a first distance of the load spacing is different than a second distance of the receptacle spacing.

17. The GFCI outlet of claim 10, wherein, during the RESETTING operation, movement of the moveable arm longitudinally causes one of the moveable load contact or the moveable receptacle contact to engage a respective one of the stationary load contact or the stationary receptacle contact prior to an other one of the moveable load contact or the moveable receptacle contact.

18. The GFCI outlet of claim 10, wherein, in the RESET state, a first contact pressure between the moveable load contact and the stationary load contact and a second contact pressure between the moveable receptacle contact and the stationary receptacle contact are substantially equal.

19. A moveable contact assembly for an electrical outlet, comprising:
a moveable load contact;
a moveable receptacle contact; and
a moveable arm bifurcated along a lateral plane at a contact end into a first planar leg and a second planar leg, the moveable load contact arranged on the contact end of the first planar leg and the moveable receptacle contact arranged on the contact end of the second planar leg,
wherein the moveable arm is moveable longitudinally into a RESET state where the moveable load contact engages a stationary load contact and the moveable receptacle contact engages a stationary receptacle contact to place the electrical outlet into normal operating conditions,
wherein the first planar leg extends in a different longitudinal plane than the second planar leg.

20. The moveable contact assembly for the electrical outlet of claim 19, wherein:
the moveable arm includes a bend forming an upper structure at a non-contact end of the moveable arm arranged opposite of the contact end, a lower structure at the contact end, and a ramp connecting the upper structure and the lower structure, and
the contact end is configured to be arranged below the stationary load contact and the stationary receptacle contact.
